(19) United States
(12) Patent Application Publication
(10) Pub. No.: US 2022/0300850 A1
(43) Pub. Date: Sep. 22, 2022

(54) END-TO-END MACHINE LEARNING PIPELINES FOR DATA INTEGRATION AND ANALYTICS

(71) Applicant: Data Gran, Inc., San Francisco, CA (US)

(72) Inventors: Carlos Mendez, Weston, FL (US); Necati Demir, Summit, NJ (US)

(73) Assignee: Data Gran, Inc., San Francisco, CA (US)

(21) Appl. No.: 17/203,345

(22) Filed: Mar. 16, 2021

(51) Int. Cl. G06N 20/00; G06N 5/04

(52) U.S. Cl. CPC G06N 20/00; G06N 5/04

(57) ABSTRACT

Exemplary embodiments of the present disclosure provide for end-to-end data pipelines (including data source, transformation of data, Machine Learning algorithms and sending the output to applications) using graphical blocks representing executable code which translate into users being able to run and deploy ML models without coding. Embodiments of the present disclosure can organize data by workspaces and projects specified in the workspace, where multiple users can access and collaborate in the workspaces and projects. The pipelines can be specified for the projects and can allow a user to access and perform operations on data from disparate data sources using one or more operators include graphical blocks that represent executable code for one or more machine learning algorithms.

### BACKGROUND

Organizations can generate an overwhelming amount of data using different applications. The way companies are managing their data today is an increasing challenge, for example silos within the departments, multiple technology stacks, the specialties needed to maintain and use that data and the way companies are organized to make sense of the data and actually take advantage of it is a growing problem.

The application of machine learning can be used to extract useful information for the data, but not only that, it could transform a company based on the insights provided. However, the process of integrating machine learning models into organizations systems can be even more cumbersome and time consuming, often taking months and requiring knowledge of computer programming languages and cloud infrastructure.

### SUMMARY

Exemplary embodiments of the present disclosure provide for an end-to-end data pipeline using graphical blocks or nodes representing executable code. Embodiments of the present disclosure can organize data by workspaces and projects specified in the workspace, where multiple users can access and collaborate in the workspaces and projects. The pipelines can be specified for the projects and can allow a user to access and perform operations on data from disparate data sources using one or more operators include graphical blocks that represent executable code for one or more machine learning algorithms, which can be trained and deployed in the pipeline without requiring the user to develop any code and without requiring the need for specialized ML Ops or Dev Ops, which typically requires collaboration and communication between data scientists, developers, business professionals and operations professionals to develop, deploy, and maintain machine learning-based systems to ensure reliability and implementation efficiency. Outputs of the pipelines can be sent directly to external applications without requiring the user build application program interfaces (APIs) to connect to external applications.

Exemplary embodiments of the present disclosure can provide a collaborative environment with embedded business intelligence tools that allow users to work together in real-time and enables organizations to centralize data (from databases, warehouses, data lakes, and business applications with structured or unstructured), visualize data, run ML models, and easily send outputs to applications without the need to write code or build application-program interfaces (APIs) to port the outputs to the applications. Embodiments of the present disclosure can provide an easy to use, user friendly, and clean user interface that does not require familiarity with computing programming languages and syntax or with programming, modeling, coding, or optimizing machine learning algorithms. Exemplary embodiments of the present disclosure can create clusters automatically; thereby eliminating the need for specialized ML Ops, which typically requires collaboration and communication between data scientists and operations professionals to develop, deploy, and maintain machine learning-based systems to ensure reliability and implementation efficiency.

In contrast to conventional techniques, which require proficiency in Python, SQL, and/or other coding languages, and can also require big data tools like Apache Spark knowledge to set up several machines (e.g., servers, virtual machines, etc.) to run machine learning models, embodiments of the present disclosure can allow users with no coding or operations experience develop and deploy ML pipelines. Typical conventional techniques can also require users to configure containers, embodiments of the present disclosure, ML pipelines can be created with requiring containers to be configured. As a result, users do not need an understanding of ML Ops and ML pipeline creation using embodiments of the present disclosure can reduce the time required to implement ML pipelines as compared to conventional techniques. Additionally, some conventional techniques cannot connect to different or external applications and/or do not have the built-in ability to send outputs of ML pipelines to applications.

In accordance with embodiments of the present disclosure, systems, method, and computer-readable media are disclosed for generating end-to-end data pipelines. The systems can include one or more non-transitory computer-readable media and one or more processors configured and programmed to execute the methods. As an example, the one or more processors can execute instructions stored in the one or more computer-readable media to render one or more graphical user interfaces for establishing a workspace and a project in the workspace; integrate data sources into the workspace from one or more data sources in response to input from a user in the one or more graphical user interfaces; render a visual editor in the one or more graphical user interfaces; populate a development window of the visual editor with graphical blocks or nodes representing executable code and lines or edges connecting the one or more graphical blocks to define a sequence of code and an order of execution of the executable code represented by the graphical blocks. The one or more processors can execute instructions stored in the one or more computer-readable media to execute the sequence of code in the order defined by the graphical blocks, and in response to execution of the executable code corresponding to at least one of the graphical blocks, send an output from the execution of the sequence of code to an application for consumption without requiring the user to generate an application program interface. As a non-limiting example, the graphical blocks can include at least first graphical block that represents an integrated data source, at least a second graphical block represents an operator, and at least a third graphical block represents an action (although fewer or more graphical blocks can be used).

In accordance with embodiments of the present disclosure the data sources that have been integrated include at least one of data from one or more data repositories, data from third party applications, or data from a pixel embedded in web content or social media content.

In accordance with embodiments of the present disclosure the processor can execute instructions to generate one or more charts based on the output from the execution of the sequence of code or in response to query code or a data filter. The query code can be automatically generated by the processor in response to a selection of one of the data sources that have been integrated and a data table in the data source that is selected.

In accordance with embodiments of the present disclosure, the processor can execute instructions to define a dashboard for the project. The dashboard can be configurable to render one or more visualizations for the data of the data sources or the output of the execution of the sequence of code.

In accordance with embodiments of the present disclosure, the processor can execute instructions to configure parameters of the executable code represented by the graphical blocks in response to input from a user.

In accordance with embodiments of the present disclosure, the processor can execute instructions to manage at least one of processor or memory resources including scaling and scheduling processor or memory resources during execution of the sequence of code.

In accordance with embodiments of the present disclosure, the processor can execute instructions to generate executable code for a pixel to track user behavior in a web content or social media content, the pixel configured to be copied and embedded in the web content or social media content.

In accordance with embodiments of the present disclosure, the second one of the graphical blocks for the operator corresponds to executable code for a machine learning algorithm, and the processor can execute instructions to train the machine learning algorithm based on input test data selected by the user, and subsequent to training the machine learning algorithm, execute the machine learning algorithm to output one or more predictions or classifications. Alternatively, or in addition, the processor can automatically define the training parameters for the machine learning algorithm based on the data contained in the data source.

Any combination and permutation of embodiments is envisioned. Other embodiments, objects, and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

In the drawings, like reference numerals refer to like parts throughout the various views of the non-limiting and non-exhaustive embodiments.

FIG. 1 is a block diagram of an exemplary end-to-end data pipeline and visualization system in accordance with embodiments of the present disclosure.

FIG. 2 depicts a computing environment within which embodiments of the present disclosure can be implemented.

FIG. 3 is a block diagram of an exemplary computing device for implementing one or more of the servers in accordance with embodiments of the present disclosure.

FIG. 4 is a block diagram of an exemplary computing device for implementing one or more of the user devices in accordance with embodiments of the present disclosure.

FIG. 5 depicts an exemplary graphical user interface (GUI) according to embodiments of the present disclosure.

FIG. 6 depicts an exemplary graphical user interface (GUI) according to embodiments of the present disclosure.

FIG. 7 depicts an exemplary graphical user interface (GUI) according to embodiments of the present disclosure.

FIG. 8 depicts an exemplary graphical user interface (GUI) according to embodiments of the present disclosure.

FIG. 9 depicts an exemplary graphical user interface (GUI) according to embodiments of the present disclosure.

FIG. 10 depicts an exemplary graphical user interface (GUI) according to embodiments of the present disclosure.

FIG. 11 depicts an exemplary graphical user interface (GUI) according to embodiments of the present disclosure.

FIG. 12 depicts an exemplary graphical user interface (GUI) according to embodiments of the present disclosure.

FIGS. 13A-E depict exemplary graphical user interfaces (GUIs) according to embodiments of the present disclosure.

FIG. 14 depicts an exemplary graphical user interface (GUI) according to embodiments of the present disclosure.

FIGS. 15A-B depict an exemplary graphical user interface (GUI) according to embodiments of the present disclosure.

FIGS. 16A-D depict an exemplary graphical user interface (GUI) according to embodiments of the present disclosure.

FIGS. 17A-B depict an exemplary graphical user interface (GUI) according to embodiments of the present disclosure.

FIG. 18 depicts an exemplary graphical user interface (GUI) according to embodiments of the present disclosure.

FIG. 19 depicts an exemplary dashboard for a project according to an embodiment of the present disclosure.

FIG. 20 is a flowchart of an exemplary process for generating a project in a workspace according to an embodiment of the present disclosure.

FIG. 21 is a flowchart illustrating an exemplary process for generating a pipeline according to embodiments of the present disclosure.

### DETAILED DESCRIPTION

Exemplary embodiments of the present disclosure provide systems, methods, and non-transitory computer-readable media to centralize data (from databases, warehouses, data lakes, and business applications with structured or unstructured), visualize data, run machine learning (ML) models, and send outputs to external applications without the need to write code or build application-program interfaces (APIs) to port the outputs to the applications via end-to-end data pipelines. Embodiments of the present disclosure can both centralize customer data from all sources and makes the data available to other systems and can collect and manage data to allow organizations to identify audience segments, optimize operations, reduce waste, etc. In a non-limiting application for marketing, embodiments of the present disclosure can be used to target specific users and contexts in online advertising campaigns.

Embodiments of the present disclosure can standardize data and processes across an organization, put into production machine learning models in seconds with a visual environment that requires no code, and provide flexible data visualization tools and reliable end-to-end customer attribution and behavior. Conventionally, organizations have to use several platforms to create end-to-end data pipelines, and this process is usually done by different teams within the company, which makes collaboration difficult and tends to reduce effectiveness, since, for example, a sales team might have to wait for a data science team to generate data reports and then for the ML Ops and Devops team to operationalize it.

Embodiments of the present disclosure can be utilized for various applications and/or use cases. As non-limiting example, embodiments of the present disclosure can be used in an application for predicting whether customers will purchase a product, improving operations and/or logistics, managing inventory, profile customers and cluster customers into groups based on the profiles for improved targeted advertising campaigns, analyzing marketing (e.g., return on investment, attribution, advertising campaign efficiency and effectiveness, and/or data organization and integration (eliminating data silos and providing actionable data across disparate data sources). While some example applications have been described, exemplary embodiments of the present disclosure can be employed for use in other any applications and other technical fields.

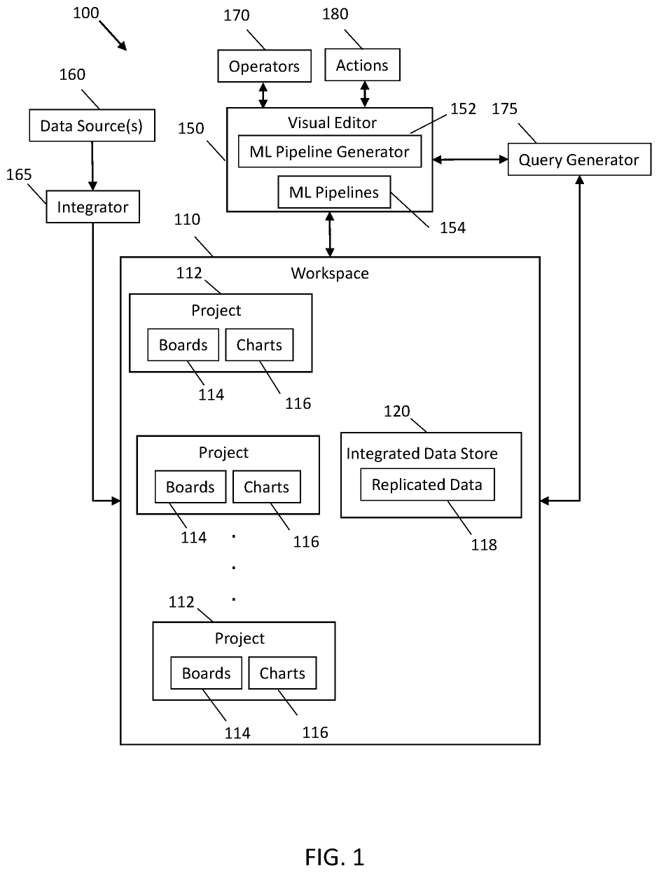

FIG. 1 is a block diagram of an exemplary end-to-end pipeline and visualization system 100 in accordance with embodiments of the present disclosure. The system 100 can include a workspace 110 and a visual editor 150. The system 100 provides for integrating data from one or more data sources (from data repositories, such as databases, warehouses, and data lakes, from business applications or third party applications with structured or unstructured data, from marketing or tracking pixels), generating one more ML pipelines for the data, defining one or more visualizations for an output of the ML pipelines, and/or outputting the output of the ML pipelines to one or more external applications to perform one or more actions using the output of the ML pipelines without requiring the use to write code, scale infrastructure cloud machines, build necessary internal tools like schedulers or build application-program interfaces (APIs) to port the outputs to the external applications.

The system 100 can significantly reduce the time and resources required to integrate machine learning algorithms in data pipelines and can significantly reduce the complexity associated with integrating the machine learning algorithms and outputting data to external applications, while providing a flexible and customizable environment to ensure reliability and implementation efficiency. The system 100 allows for the creation of ML pipelines without requiring containers to be configured so that users do not need an understanding of conventional ML Ops and ML pipeline creation. Additionally, the system 100 can automatically manage resources for scaling and scheduling executing of code represented by pipelines. Additionally, the system 100 connects to different or external applications and has the built-in ability to send outputs of ML pipelines to external applications without requiring the user to build APIs.

The system 100 can include one or more graphical user interfaces (GUIs) to allow users to interact with the workspaces 110 and the visual editor 150 of the system 100. The GUIs can be rendered on display devices and can include data output areas to display information to the users as well as data entry areas to receive information from the users. For example, data output areas of the GUIs can output information associated with data that has been integrated with or collected by the system from one or more data sources, SQL queries, visualizations, ML models, ML pipelines and any other suitable information to the users via the data outputs and the data entry areas of the GUIs can receive, for example, graphical blocks or nodes representing executable code for ML pipeline generation, user information, data parameters, SQL query parameters, machine learning parameters, and any other suitable information from users. Some examples of data output areas can include, but are not limited to text, visualizations of data and graphics (e.g., tables, graphs, pipelines, images, and the like), and/or any other suitable data output areas. Some examples of data entry fields can include, but are not limited to editor windows, text boxes, check boxes, buttons, dropdown menus, and/or any other suitable data entry fields.

The GUIs of the workspace 110 allow users to define new workspaces, create projects 112 within a workspace, and define who within an organization to associate with the workspace and/or the individual projects 112 created within the workspace 110. Upon creation of the workspace 110, a user can identify and select data sources 160 to be associated with the workspace 110. When the data sources 160 are selected by the user via one of the GUIs associated with the workspace 110, the system 100 execute a data integrator 165 of the system 100 to copy or replicate data from the selected data sources 160 and can store the replicated data 118 from the selected data source 160 as secure and encrypted replicated integrated data sources 120. As part of the data source integration process, the system 100 can allow the user to specify parameters including a frequency with which the system 100 synchronizes the stored replicated data with the data in the data sources 160 to update the replicated data to match the data from the data sources 160. Users can also choose the specific streams and type of replication. In an exemplary non-limiting embodiment, the system 100 can integrate data from, for example, Postgres, MySQL, Salesforce, Hubspot, Sendgrid, and other data sources.

The system 100 can also collect user events via a software development kit (SDK) from web and mobile apps to provide a complete and centralized data overview. For example, the system 100 can employ a JavaScript library that uses pixel-based technology (e.g., tracker or marketing pixels) to implement behavioral tracking, e.g., user browsing information. As one example, users can embed pixels generated by the system 100, which represent executable code, in web content and/or social media content to determine actions taken by a user with respect to the web and/or social media content (e.g., when the content is loaded/viewed, data entered in forms (except passwords), hyperlinks or elements selected, as well as other actions). Organizations can use pixels to determine how effective their digital advertising is, develop targeted advertising to users, and/or determine sources attributed to directing users to the web or social media content. The system 100 can append user browsing information from the pixels to a dynamic pixel download request which carries the information in a request query string. When the pixel is downloaded, it generates and stores a server-side log, which can be processed by the system 100 into meaningful reports. This process can be asynchronously so that it does not interfere or slow down a normal page load process. Data is processed in near real-time and users can view and verify their traffic statistics after placing the pixel.

The data source integration provided by the integrator 165 of system 100 allows users to quickly connect to enterprise data warehouses and to start the process of analyzing the data that has been collected, e.g., using BigQuery, Cosmos DB or Redshift. The replicated data 118 can be cleaned by the system 100, and redundant or repetitive data in the replicated data 118 can be removed by the system 100. The system 100 also can structure the replicated data 118 so that the replicated data 118 is transformed into a format for analysis and/or processing by the system 100. Once data from one of the data sources is integrated into the workspace as the replicated data 118, the replicated data 118 can be available for use by all of the projects 112 in the workspace 110. The data source integration allows users to act on the replicated data 118 in each of the individual projects 112 in the workspace 110 without having to separately upload and download data from different data sources to different external systems, also provides for standardization of data in the replicated data 118 across all projects 112 in the workspace 110, and facilitates collaboration across the projects 112 within the workspace 110 and between users of the workspace 110. Integrating the data sources 160 at the level of the workspace 110 can guarantee that the same data set, tools, and procedures are available at the level of the projects 112 the users associated with each of the different projects 112 created in the workspace 110.

Once the workspace 110 is created, the user can create one or more projects 112 within the workspace 110. The projects 112 can be independently defined and can be connected to the replicated data 118 from one or more of the data sources integrated into the workspace 110 associated with the projects 112. Upon creation of the project(s) 112, the user can create one or more boards 114 and/or one or more charts 116 for the project(s) 112. The boards 114 can be used to centralize relevant information from a project or a client in one place, in real-time or batch. Visualizations of data from the projects 112 can be saved in the boards 114. The charts 116 can be created via SQL queries or filters that need no code. The charts can be created using the replicated data before or after and/or independently of one or more operators associated with a pipeline. As one example, after the data sources 160 are integrated into the workspace 110, the user can select a table from the replicated data 118 associated with one or more of the data sources 160 and can apply one or more SQL queries and/or filters to the replicated data 118 in the selected table. As another example, the replicated data 118 associated with one or more integrated data sources can be processed using one or more operators 170, and the output of the one or more operators 175 can be used to create one or more of the charts 116 and/or one or more actions 180 as described herein. The system 100 allows a user to manually enter SQL code for querying the data tables of the replicated data 118 associated with one or more integrated data sources. Alternatively, one or more SQL code queries can be automatically generated by the system 100 via a query generator 175. For example, the query generator 175 automatically creates or builds an SQL code query in response to receiving selection of data parameters (e.g., data, filters, groups and conditions) without requiring the user to know how to code. The charts 116 can be connected to one or more of the integrated data sources from which the data that is required for the chart is stored so the charts 116 can be automatically updated when the system 100 synchronizes the replicated data 118 in the system 100 with the data in the data sources 160. The charts 116 can be saved to a charts section and/or can be saved to one of the boards 114 in a respective one of the projects 112. One or more different chart types can be selected by the user (e.g., a pie chart, a bar graph, a frequency chart, area chart, a line graph, among others).

The query generator 175 can be configured to create one or more queries (e.g., SQL database queries) in response to the user selecting an integrated data source and data table from the integrated data source. In some embodiments, the query generator 175 can include a query editor that allows a user to manually enter a code and/or that allows a user to modify the code created or built by the query generator 175. Some examples of query languages include Structured Query Language (SQL), Contextual Query Language (CQL), proprietary query languages, domain specific query languages and/or any other suitable query languages. In some embodiments, the query generator 175 can also transform the query code into one or more queries in one or more programming languages or scripts, such as Java, C, C++, Perl, Ruby, and the like.

The GUIs of the visual editor 150 can include a ML pipeline generator 152 that includes a development window within which a user can place and connect graphical blocks representing executable code modules corresponding to integrated data sources, operators 170, and actions 180. The graphical blocks can be connected in the development window to specify an execution flow of the graphical blocks. For example, an output of a graphical block corresponding to the data source integration can be connected with a line(s) to be an input to one or more graphical blocks for operators 170, and the output of the graphical blocks corresponding to the operators 170 can be connected as inputs to other operators 170 and/or can be connected to one or more actions 180. The graphical blocks provide options that allow the user to configured and/or modify parameters corresponding to inputs to and outputs of the executable code represented by the graphical blocks and can allow the user to configure parameters of operations and/or function performed by the graphical block upon execution of the code represented by the graphical blocks by one or more processors.

The graphical blocks for the integrated data sources can represent executable code for connecting to the replicated data 118 in the integrated data sources 120, where the replicated data 118 stored by the system 100 in one or more data storage devices. Using the graphical blocks for data source integrations allows users to quickly start analyzing the replicated data 118. To include a data integration in a pipeline, the user can place a graphical block corresponding to the selected data integration into the development window, which makes the replicated data related to the data source represented by the graphical block available for use in the pipeline being created in the development window.

The graphical blocks for the operators 170 can represent executable code for functions and/or algorithms including machine learning algorithms that can receive, as an input, data from the one or more graphical blocks that have been added to the development window. As an example, graphical blocks can include executable code modules for data source integration, database query generation, operators and algorithms, visualizations/graphics generation, training machine learning algorithms, deploying trained machine learning models, actions to be performed on the output of the operators and algorithms. As one example, the graphical blocks for the operators can represent executable code modules for de-duplicating, cleaning, querying, aggregating, joining and/or structuring the replicated data 118 that is replicated from the data sources added to the pipeline so that the replicated data 118 can be transformed into a format for consumption by subsequent graphical blocks in the pipeline being developed in the development window. Other examples of operators 170 can include a recommended product algorithm; recency, frequency, monetary (RFM) analysis and RFM score generation; algorithms; and custom SQL. As one example, the custom SQL operator can allow a user to run SQL query with or without coding, which can be useful when the user wants to visualize, organize, and/or prepare data for multiple operators 170 or actions 180. As another example, the system 100 can use RFM analysis to transform recency, frequency, and monetary values in an RFM analysis into a score, where the higher the score, the more likely it is that a customer will respond to an offer.

The operators 170 represented as graphical blocks corresponding to executable code can include one or more machine learning algorithms as well as code for training and deploying the machine learning algorithms in the pipelines. The machine learning algorithms included in the operators 170 can include, for example, supervised learning algorithms, unsupervised learning algorithm, artificial neural network algorithms, artificial neural network algorithms, association rule learning algorithms, hierarchical clustering algorithms, cluster analysis algorithms, outlier detection algorithms, semi-supervised learning algorithms, reinforcement learning algorithms collaborative filtering algorithms (e.g., alternating least squares), pattern discovery (e.g., Prefix span), dimensionality reduction (e.g., principal component analysis, singular value decomposition), and/or deep learning algorithms Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Ridge regression, Lasso regression, Isotonic regression, Multinomial logistic regression, Naive Bayes classifier, Perceptron, and/or Support vector machines; Quadratic classifiers; k-nearest neighbor; Boosting (e.g., Gradient boost); Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Bisecting K-means, Streaming K-means, Fuzzy clustering; DBSCAN, Gaussian mixture, Power iteration clustering, Latent Dirichlet allocation; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory.

In exemplary embodiments, the system 100 can provide an AutoML option. The AutoML option enables users to deploy machine learning algorithms in the pipelines without requiring the user to specify the particular machine learning algorithms to be used. As an example, the user can include an Auto ML graphical block in a pipeline, which can run multiple machine learning algorithms in parallel or sequentially based on data received as an input to the AutoML graphical block. The AutoML tries to find the best ML model based on the metrics provided by ML models; such as accuracy, mean squared error, etc. AutoML can decide to combine multiple machine learning models and can use voting schemes, weighting schemes, or any other suitable schemes, or may use a single mode. The AutoML module can also pre-process the data automatically to increase the values of metrics (accuracy, mse, etc. . . . ) and decrease the error rate.

In exemplary embodiments, the system 100 can allow a user to specify training data, test data, and production data to be processed by the machine learning algorithms included in a pipeline or can automatically specify training data, test data, and production data without input from the user. As one example, when a user adds a graphical block corresponding to a machine learning algorithm to a pipeline, the user can click on the graphical block to open a menu that allows the user to specify particular data sets from data in an integrated data source as training data, test data, and production data. As another example, the system 100 can automatically divide data being input to the graphical block representing the machine learning algorithm into a training data set and a test data set. In some embodiments, the system 100 can equally divide the data into the training data set and the test data set. In some embodiments, the system 100 can determine a minimum amount of training and test data required to train and validate a particular machine learning algorithm and can specify a training data set and a test data set based on the determination of the minimum amount of data required.

Once the replicated data 118 is processed via one or more of the operators 170 to define one or more data sets for the pipeline being developed in the development window, additional operators 170 can be added to the pipeline to consume the data sets, e.g., by adding algorithms to be executed on the data sets or choosing the Auto ML option (which runs multiple algorithms at the same time). As one example, graphical blocks representing executable code for clustering or linear regression algorithms can be added to act upon the data sets and output, e.g., clusters of products with high or low values, sales predictions with a specific product, and/or other data analyses. As another example, a graphical block representing executable code for a custom funnel operation can be used if the user selected a pixel or SDK as data source. The custom funnel operator can allow the user to select events and create a funnel over a period of time, and the funnel operator can output a table with different columns based on the specified period of time for the funnel operator. The schema of the table can be a system identifier, a session identifier, and a client identifier. The client identifier can be a unique identifier for each visitor to a page set by the client.

The graphical blocks for the actions 180 can represent executable code for a specific type of operator that communicates with applications external to the system 100, without requiring the user to build an API, and/or with applications embedded in the system 100. The actions 180 allows users to send the output of a pipeline 154 into a specific businesses application. To use the actions 180, the graphical blocks of the actions 180 can be dragged and dropped into the pipeline, eliminating the need to set up each specific platform and without requiring the user to build an API to interface with the application associated with the selected action 180. Some examples of actions can include an e-mail campaign generator, a chatbot generator, a chart visualization generator, an SMS generator, an advertising campaign generator, and a spreadsheet generator. As an example, an email campaign action can trigger the automatic creation and transmission of emails based on the results of the previous operators 170 in the pipeline 154. Example of applications to which the actions 180 send the output of a pipeline can include, but are not limited to Google Sheets, BigQuery, Campaign Monitor, Twilio, Facebook, Google, Intercom, an email function, a messaging function (e.g., SMS), and a push notifications function. Another exemplary action supported by the system 100 can be an API Exporter action that converts operators to an API endpoint to facilitate consumption of the processed data by other applications based on a GET request. Another exemplary action supported by the system 100 is a webhook action based on a POST request, which can be used to push data in an operator to a user-defined endpoint in a specified format (e.g., a JavaScript Object Notation or JSON format). To use the webhook action, an endpoint can be implemented by the user to handle the requests coming from the webhook action. When building pipelines, chart generation algorithms can be integrated into the pipelines as an action that outputs a visualization of data.

After a graphical block is added to the editor 150, the user can edit and/or configure parameters of the executable code represented by the graphical block. For example, after a linear regression block is added to the editor, the user can configure parameters of the linear regression algorithm by selecting an input table, x column parameters and y column parameter upon which the linear regression is to be performed, and also allows the user to specify a node count and node type as part of a spark configuration. In some embodiments, non-Spark algorithms can be included as operators 170 such that no configuration of Spark is required.

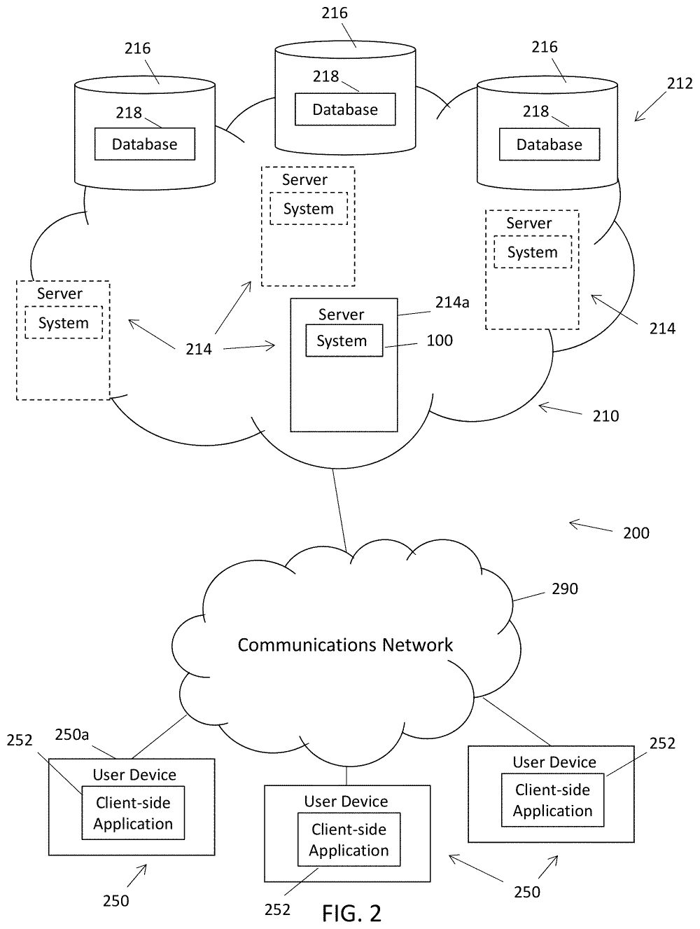

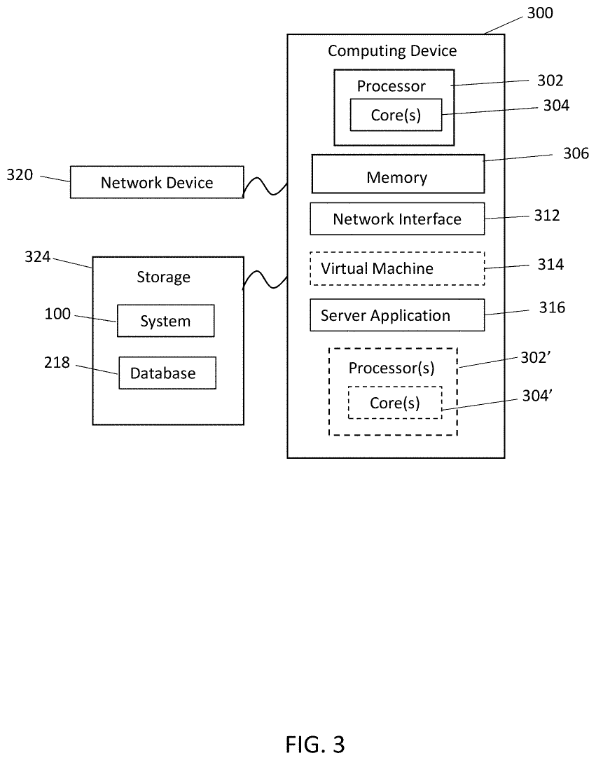

FIG. 2 depicts a computing environment 200 within which embodiments of the present disclosure can be implemented. As shown in FIG. 2, the environment 200 can include distributed computing system 210 including shared computer resources 212, such as servers 214 and (durable) data storage devices 216, which can be operatively coupled to each other. For example, two or more of the shared computer resources 212 can be directly connected to each other or can be connected to each other through one or more other network devices, such as switches, routers, hubs, and the like. Each of the servers 214 can include at least one processing device (e.g., a central processing unit, a graphical processing unit, etc.) and each of the data storage devices 216 can include non-volatile memory for storing databases 218. The databases 218 can store data 220 including, for example, workspaces 110, projects 112, boards 114, charts 116, the replicated data 118, generated data sets, pipelines 154, outputs of the pipelines 154, operators 170, and actions 180. An exemplary server is depicted in FIG. 3.

Any one of the servers 214 can implement instances of the system 100 and/or the components thereof. In some embodiments, one or more of the servers 214 can be a dedicated computer resource for implementing the system 100 and/or components thereof. In some embodiments, one or more of the servers 214 can be dynamically grouped to collectively implement embodiments of the system 100 and/or components thereof. In some embodiments, one or more servers can dynamically implement different instances of the system 100 and/or components thereof.

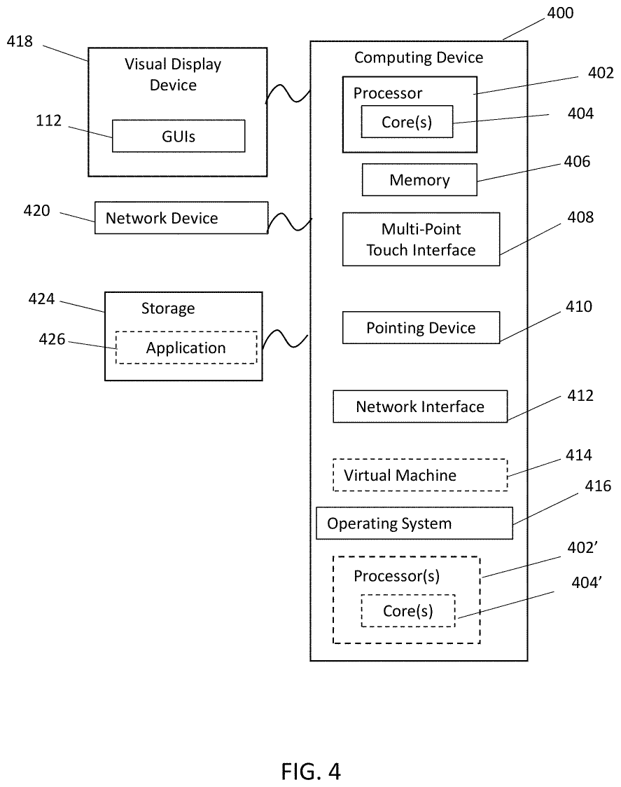

The distributed computing system 210 can facilitate a multi-user, multi-tenant environment that can be accessed concurrently and/or asynchronously by user devices 250. For example, the user devices 250 can be operatively coupled to one or more of the servers 214 and/or the data storage devices 216 via a communication network 290, which can be the Internet, a wide area network (WAN), local area network (LAN), and/or other suitable communication network. The user devices 250 can execute client-side applications 252 to access the distributed computing system 210 via the communications network 290. The client-side application(s) 252 can include, for example, a web browser and/or a specific application for accessing and interacting with the system 100. In some embodiments, the client side application(s) 252 can be a component of the system 100. An exemplary user device is depicted in FIG. 4.

In exemplary embodiments, the user devices 250 can initiate communication with the distributed computing system 210 via the client-side applications 252 to establish communication sessions with the distributed computing system 210 that allows each of the user devices 250 to utilize the system 100, as described herein. For example, in response to the user device 250a accessing the distributed computing system 210, the server 214a can launch an instance of the system 100. In embodiments which utilize multi-tenancy, if an instance of the system 100 has already been launched, the instance of the system 100 can process multiple users simultaneously. The server 214a can execute instances of each of the components of the system 100 according to embodiments described herein. The users can interact in a single shared session associated with the system 100 and components thereof or each user can interact with a separate and distinct instance of the system 100 and components thereof, and the instances of the systems and components thereof. Upon being launched, the system 100 can identify the current state of the data stored in the databases in data storage locations of one or more of the data storage devices 216. For example, the server 214a can load the workspaces 110, the projects 112, boards 114, charts 116, the replicated data 118, generated data sets, pipelines 154, data output by the pipelines 154.

In exemplary embodiments, the system 100 can automatically manage resources when executing one or more pipelines. In some instances, the amount of memory and processor resources required during the execution of a pipeline can vary and can be dependent on the amount of data in the data sets being consumed in the pipeline. The system 100 can scale the memory allocated to the execution of the pipeline and/or can scale the processor resources for executing the pipelines. As an example, when the system 100 determines that more processor resources are required, the system 100 can add more processors or processor cores from the servers 214 to execute the pipeline. The determination by the system 100 to add additional processor resource can be made by the system 100 based on estimating a time required or a number of operation to be performed to complete the execution of the pipeline and determining one or more parameters (frequency, operations per time/cycle, cache, etc.) of the processors available for executing the pipeline. The system 100 can also allocate memory resources in the distributed computing system 210 based on an amount of data being processed during execution of the pipeline. The system 100 can also manage scheduling of the execution of various blocks or nodes in the pipeline (e.g., scheduling of Machine Learning pipeline jobs) based on available processor and/or memory resources and can allocate processor and memory resources to execute the pipelines in an efficient manner.

FIG. 3 is a block diagram of an exemplary computing device 300 for implementing one or more of the servers 214 in accordance with embodiments of the present disclosure. In the present embodiment, the computing device 300 is configured as a server that is programmed and/or configured to execute one of more of the operations and/or functions for embodiments of the environment described herein (e.g., system 100) and to facilitate communication with the user devices described herein (e.g., user device(s) 250). The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more solid state drives), and the like. For example, memory 306 included in the computing device 300 can store computer-readable and computer-executable instructions or software for implementing exemplary embodiments of the components/modules of the system 100 or portions thereof, for example, by the servers 214. The computing device 300 also includes configurable and/or programmable processor 302 and associated core 304, and optionally, one or more additional configurable and/or programmable processor(s) 302′ (e.g., central processing unit, graphical processing unit, etc.) and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device may be shared dynamically. One or more virtual machines 314 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

The computing device 300 may include or be operatively coupled to one or more data storage devices 324, such as a hard-drive, CD-ROM, mass storage flash drive, or other computer readable media, for storing data and computer-readable instructions and/or software that can be executed by the processing device 302 to implement exemplary embodiments of the components/modules described herein with reference to the servers 214.

The computing device 300 can include a network interface 312 configured to interface via one or more network devices 320 with one or more networks, for example, a Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections (including via cellular base stations), controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. While the computing device 300 depicted in FIG. 3 is implemented as a server, exemplary embodiments of the computing device 300 can be any computer system, such as a workstation, desktop computer or other form of computing or telecommunications device that is capable of communication with other devices either by wireless communication or wired communication and that has sufficient processor power and memory capacity to perform the operations described herein.

The computing device 300 may run any server operating system or application 316, such as any of the versions of server applications including any Unix-based server applications, Linux-based server application, any proprietary server applications, or any other server applications capable of running on the computing device 300 and performing the operations described herein. An example of a server application that can run on the computing device includes the Apache server application.

FIG. 4 is a block diagram of an exemplary computing device 400 for implementing one or more of the user devices (e.g., user devices 250) in accordance with embodiments of the present disclosure. In the present embodiment, the computing device 400 is configured as a client-side device that is programmed and/or configured to execute one of more of the operations and/or functions for embodiments of the environment described herein (e.g., client-side applications 252) and to facilitate communication with the servers described herein (e.g., servers 214). The computing device 400 includes one or more non-transitory computer-readable media for storing one or more computer-executable instructions or software for implementing exemplary embodiments of the application described herein (e.g., embodiments of the client-side applications 252, the system 100, or components thereof). The non-transitory computer-readable media may include, but are not limited to, one or more types of hardware memory, non-transitory tangible media (for example, one or more magnetic storage disks, one or more optical disks, one or more solid state drives), and the like. For example, memory 406 included in the computing device 400 may store computer-readable and computer-executable instructions, code or software for implementing exemplary embodiments of the client-side applications 252 or portions thereof. In some embodiments, the client-side applications 252 can include one or more components of the system 100 such that the system is distributed between the user devices and the servers 214. For example, the client-side application can include the visual editor 150. In some embodiments, the client-side application can interface with the system 100, where the components of the system 100 reside on and are executed by the servers 214.

The computing device 400 also includes configurable and/or programmable processor 402 (e.g., central processing unit, graphical processing unit, etc.) and associated core 404, and optionally, one or more additional configurable and/or programmable processor(s) 402′ and associated core(s) 404′ (for example, in the case of computer systems having multiple processors/cores), for executing computer-readable and computer-executable instructions, code, or software stored in the memory 406 and other programs for controlling system hardware. Processor 402 and processor(s) 402′ may each be a single core processor or multiple core (404 and 404′) processor.

Virtualization may be employed in the computing device 400 so that infrastructure and resources in the computing device may be shared dynamically. A virtual machine 414 may be provided to handle a process running on multiple processors so that the process appears to be using only one computing resource rather than multiple computing resources. Multiple virtual machines may also be used with one processor.

Memory 406 may include a computer system memory or random access memory, such as DRAM, SRAM, MRAM, EDO RAM, and the like. Memory 406 may include other types of memory as well, or combinations thereof.

A user may interact with the computing device 400 through a visual display device 418, such as a computer monitor, which may be operatively coupled, indirectly or directly, to the computing device 400 to display one or more of graphical user interfaces of the system 100 that can be provided by or accessed through the client-side applications 252 in accordance with exemplary embodiments. The computing device 400 may include other I/O devices for receiving input from a user, for example, a keyboard or any suitable multi-point touch interface 408, and a pointing device 410 (e.g., a mouse). The keyboard 408 and the pointing device 410 may be coupled to the visual display device 418. The computing device 400 may include other suitable I/O peripherals.

The computing device 400 may also include or be operatively coupled to one or more storage devices 424, such as a hard-drive, CD-ROM, or other computer readable media, for storing data and computer-readable instructions, executable code and/or software that implement exemplary embodiments of an application 426 or portions thereof as well as associated processes described herein.

The computing device 400 can include a network interface 412 configured to interface via one or more network devices 420 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 412 may include a built-in network adapter, network interface card, PCMCIA network card, card bus network adapter, wireless network adapter, USB network adapter, modem or any other device suitable for interfacing the computing device 400 to any type of network capable of communication and performing the operations described herein. Moreover, the computing device 400 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the processes and/or operations described herein.

The computing device 400 may run any operating system 416, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the processes and/or operations described herein. In exemplary embodiments, the operating system 416 may be run in native mode or emulated mode. In an exemplary embodiment, the operating system 416 may be run on one or more cloud machine instances.

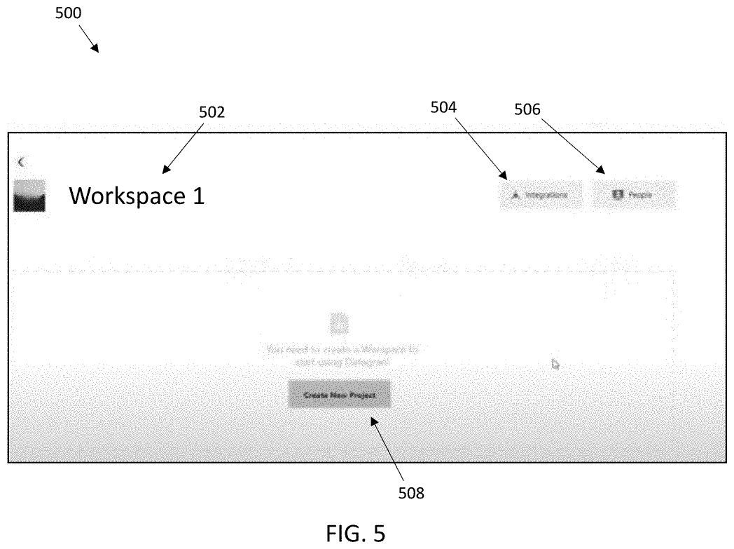

FIG. 5 depicts an exemplary graphical user interface (GUI) 500 for a workspace 110 of an embodiment of the system 100. As shown in FIG. 5, the workspace 110 can have a name 502 (“Workspace 1”) and the GUI 500 can include selectable options 504, 506, and 508. In response to selection of option 504, the system 100 can render a GUI that allows the user to specify data sources to integrate into the workspace 110. Once the data sources are integrated into the workspace (e.g., when the replicated data is generated), a user can create one or more pipelines that consume the data. In response to selection of the option 506, the system 100 can render a GUI that allows the user to invite other users to the workspace 110. In response to selection of option 508, the system 100 can allow the user to create a new project 112 in the workspace 110, within which the user can create one or more pipelines.

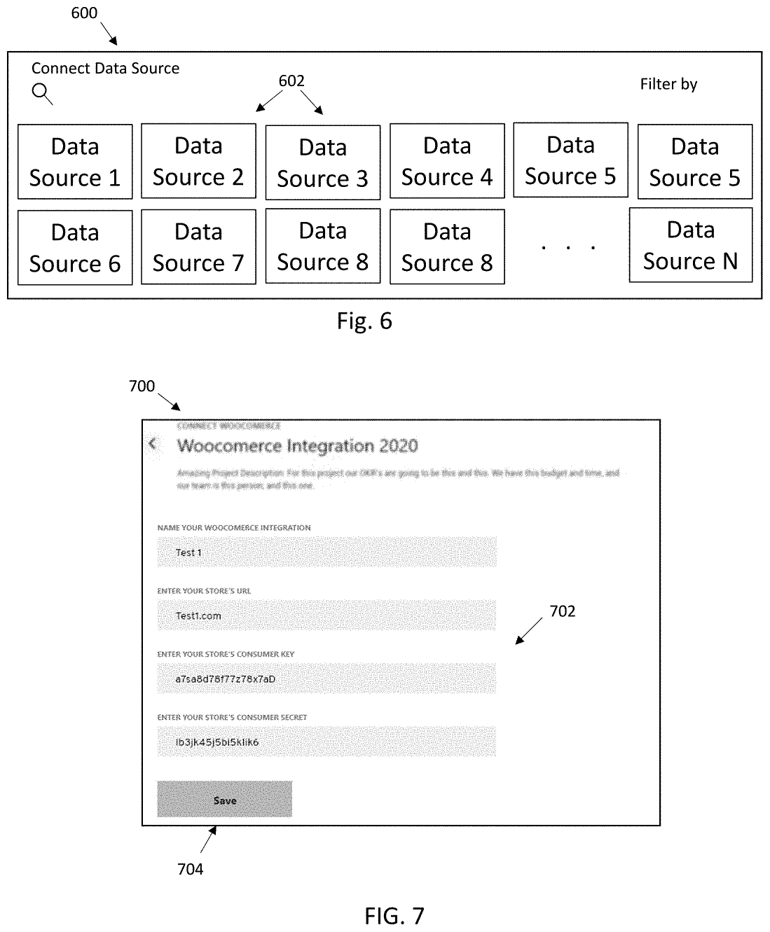

FIG. 6 depicts an exemplary graphical user interface (GUI) 600 of an embodiment of the system 100. The GUI 600 allows users to select from one or more data sources 160 that can be integrated into a workspace. In example, embodiment the GUI 600 can be rendered on a display by the system 100 in response to selection of option 504 in GUI 500. As shown in FIG. 6, the GUI 600 can include icons 602 corresponding to data sources 160 that can be integrated into the workspace 110. The user can select one or more of the icons 602 and the system 100 can create replicated data for each of the data sources corresponding to the icons 602.

FIG. 7 depicts an exemplary graphical user interface (GUI) 700 of an embodiment of the system 100. The GUI 700 is an example GUI that can be rendered on a display in response to a selection to integrate one of the data sources 160. The GUI 700 allows a user to specify one or more parameters for the data sources via data entry fields 702 to facilitate connection of the system 100 to the data source and/or to specify data to be replicated by the system 100. As a non-limiting example, the user can select an icon 602 corresponding to a “Woocomerce” data source and the GUI 700 can the data entry fields 702 that allow the user to specify a name for the data source being integrated, a universal resource locator (URL) for a store, a consumer key for the store, and a consumer secret for the store. The data entered in fields 702 can be used by the system as credentials to interface with the data source to allow the system 100 to connect to and copy data from the data source. After the data entry fields 702 have been populated, the user can select a save option 704 to save the parameters entered in the fields 702.

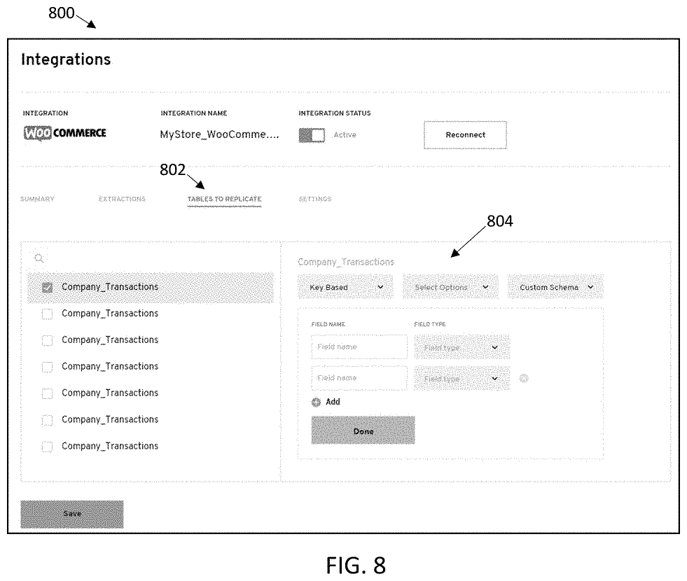

FIG. 8 depicts an exemplary graphical user interface (GUI) 800 of an embodiment of the system 100. In some embodiments, the system 100 can allow the user to specify subsets of data to replicate from a data source. For example, the GUI 800 can be rendered by the system 100 to allow the user to identify specific data tables in the data source to replicate in response to a selection of an option 802 and allow the user to specify additional elements in the data in the data source to replicate via an option 804.

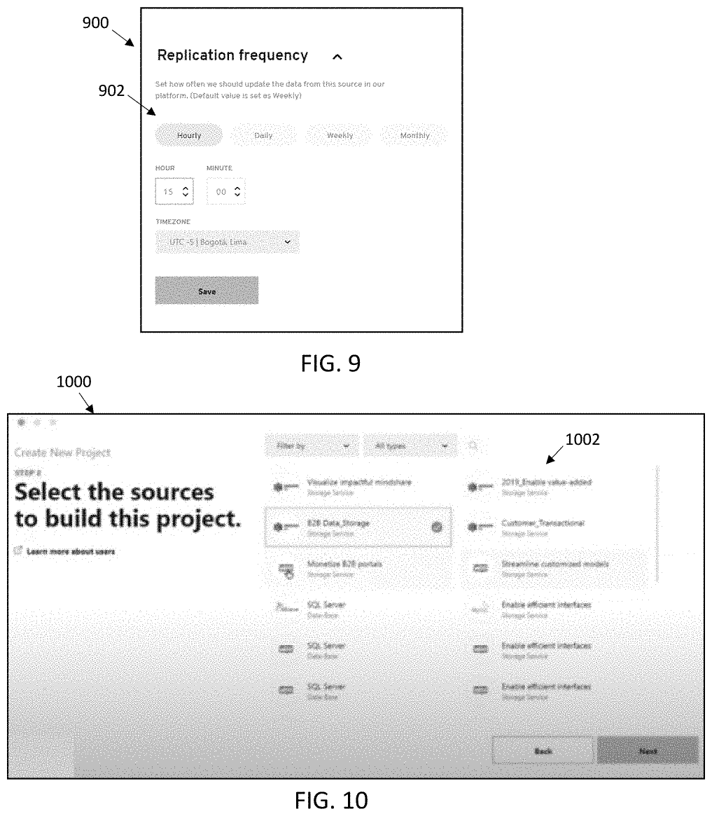

FIG. 9 depicts an exemplary graphical user interface (GUI) 900 of an embodiment of the system 100 that allows the user to specify a replication frequency for a selected data source. As shown in FIG. 9, the GUI 900 can include data entry fields 902 that allow the user to specify the frequency (e.g., hourly, daily, weekly, monthly) and time at which the system can synchronize the replicated data with the data in the data source.

FIG. 10 depicts an exemplary graphical user interface (GUI) 1000 of an embodiment of the system 100 that can be rendered by the system 100. As shown in FIG. 10, the GUI 1000 can include icons 1002 for the data sources that have been integrated into the system 100 and that can be selected for consumption by a new project.

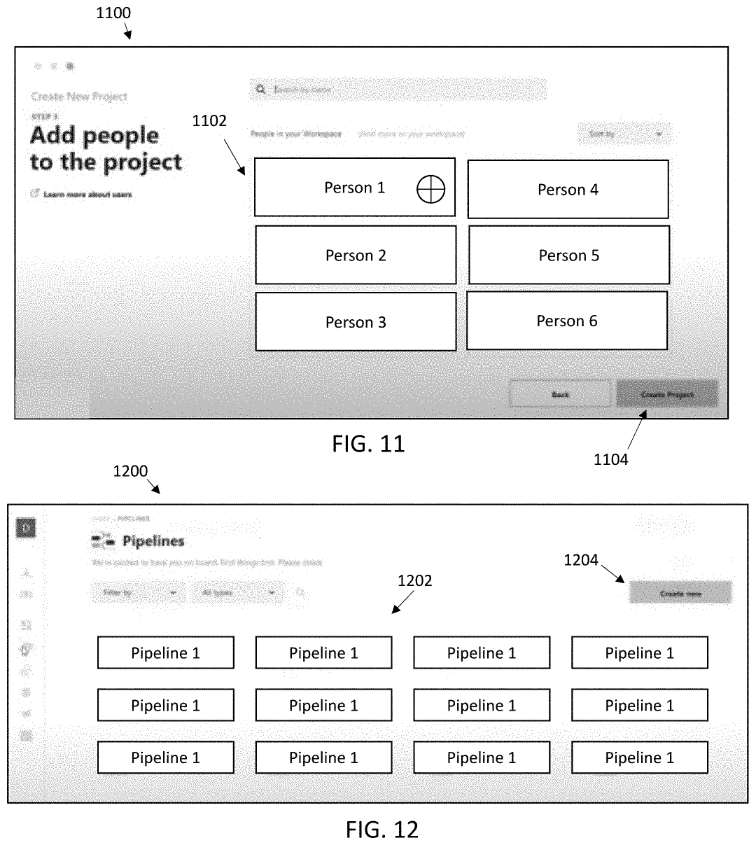

FIG. 11 depicts an exemplary graphical user interface (GUI) 1100 of an embodiment of the system 100 that can be rendered by the system 100. The GUI 1100 can allow the user to invite other users to a project. As shown in GUI 1100, the GUI 110 can include a list 1102 of users that can be invited to the project, where selection of one or more of the users from the list 1102 can be used to invite the one or more users to the project. After the users have been invited, the user can select a “Create Project” option that recreates a project 112 in the workspace 110. After a project is created, one or more pipelines can be generated for the project and/or one or more charts can be generated for the project.

FIG. 12 depicts an exemplary graphical user interface (GUI) 1200 of an embodiment of the system 100 that can be rendered by the system 100. The GUI 1200 shows selectable icons 1202 for pipelines that have been created for a selected project. The user can select one of the icons 1202 to open a pipeline corresponding to the selected icon 1202 in the visual editor 150 to allow the user to modify the pipeline. The GUI 1204 can also include an option 1204 to create a new pipeline for the selected project.

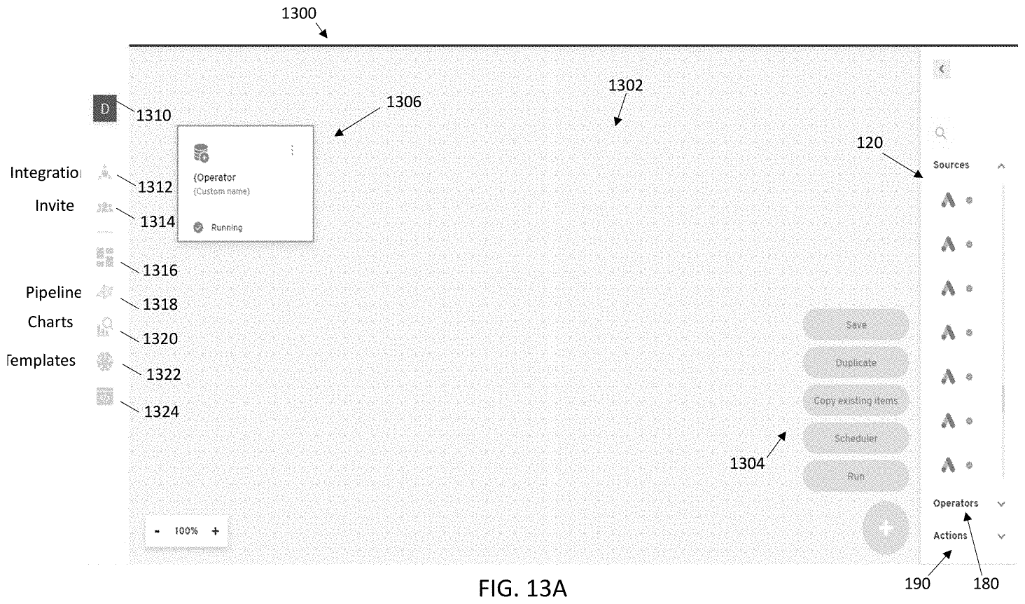

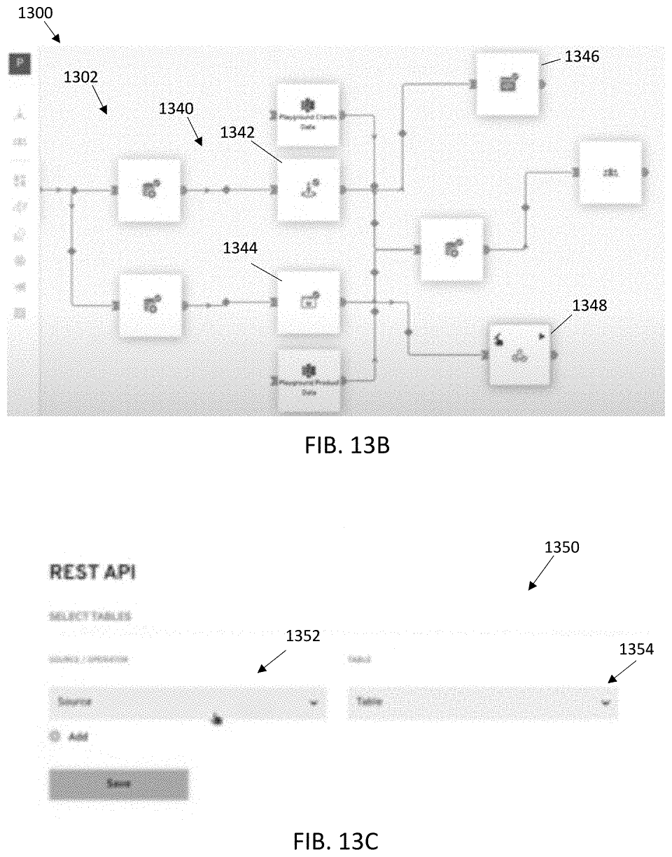

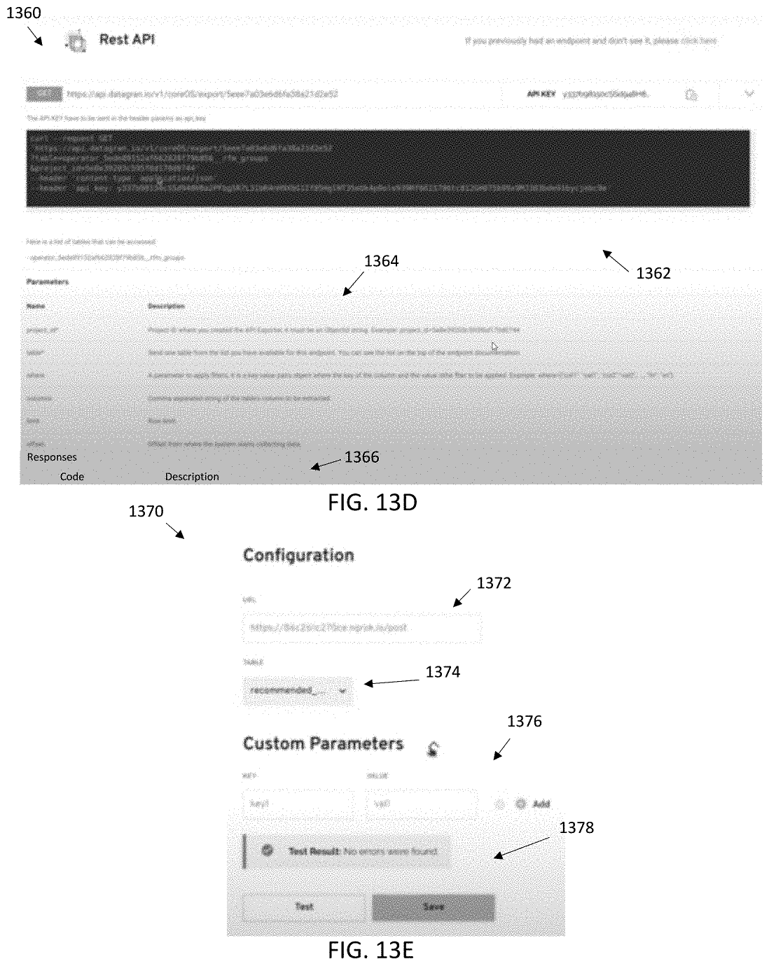

FIG. 13A depicts an exemplary graphical user interface (GUI) 1300 of an embodiment of the system 100 that can be rendered by the system 100. The GUI 1300 includes the visual editor 150 having a development window 1302 within which a pipeline can be generated. The user can select one or more graphical blocks corresponding to integrated data sources 120, operators 170, and actions 190. As one example, the user can drag and drop a graphical block 1306 into the visual editor 150. The user can select one or more option 1304 in the visual editor 150, such as saving the pipeline, duplicating the pipeline, copy one or more graphical blocks, scheduling an execution of the pipelines, executions or running the pipeline. The GUI 1300 can also include one or more options for navigating to different graphical user interfaces include a “dashboard” option that allows the user to see and navigate to different pipelines in the project, an option 1312 to integrate data sources into the workspace, an option 1314 to invite people to the project, an option 1316 to view boards for the project to which the pipeline is associated, an option 1318 to navigate to the visual editor 150, an option to generate one or more charts, an option to incorporate one or more templates into the project, and an option 1324 to review any APIs the system has built for a specific pipeline.

FIG. 13B depicts the graphical user interface (GUI) 1300 having an example pipeline 1340 that have been generated in the development window 1302. As an example, the pipeline 1340 can include a graphical block 1342 that corresponds to an operator (e.g., the RFM operator, which segments customers and gives them labels based on their purchase behavior) and can include a graphical block 1344 that corresponds to an operator (e.g., the Recommended Products operator, which can recommend products that customers may be interested in purchasing with a probability that the customer will purchase each product). An output of the operator represented by the graphical block 1342 can be connected to a graphical block 1346 that corresponds to an API Exporter action. The API Exporter action builds an API for the user, without requiring the user to write code, and via a Get request it can communicate with an external application upon execution of the executable code represented by the graphical block 1344. An output of the operator represented by the graphical block 1344 can be connected to a graphical block 1348 that represents a webhook action. The webhook action can push data in an operator (e.g., the operator represented by the graphical block 1344) to a user-specified endpoint using a pre-defined json format. The data can be sent as a POST request and the data can be stored as json format in the body of the request.

FIG. 13C depicts a graphical user interface (GUI) 1350 through which a user can specify data that allows the system 100 to generate a REST API for interfacing an output of a graphical block 1342 in the pipeline shown FIG. 13B to an external application. The GUI 1350 can be rendered on a display in response to the user clicking on the graphical block 1346 in FIG. 13B and selecting an edit or configure option in a menu that is displayed. The user can specify the source/operator 1352 and specific data table(s) 1354 to be passed to an external application via the API represented by graphical block 1346, which can be used by the system 100 to build the API for the user.

FIG. 13D depicts a graphical user interface 1360 that can be rendered in response to a selection of the option 1326 to allow a user to review details about an API that has been generated by the system 100 for the pipeline shown in FIG. 13B. As shown in FIG. 13D, the API code 1362, parameters 1364 of the API, and responses 1366 for the API generated by the system 100 can be displayed.

FIG. 13E depicts a graphical user interface (GUI) 1370 through which a user can specify a URL 1372 and a data table 1374 (e.g., Recommended products in the present example) that allows the system 100 to push the data from the data table output from the graphical block 1344 in the pipeline shown FIG. 13B to an endpoint. The GUI 1370 also allows the user to specify customer or fixed parameters 1376 using the key and value for the parameters. The user can run a test in the GUI 1370 in response to selection of a test option 1378 to ensure that the webhook action is functioning properly. The GUI 1350 can be rendered on a display in response to the user clicking on the graphical block 1346 in FIG. 13B and selecting an edit or configure option in a menu that is displayed. The user can specify the source/operator 1348 and specific data table(s) 1350 to be passed to an external application via the API represented by graphical block 1346, which can be used by the system 100 to build the API for the user.

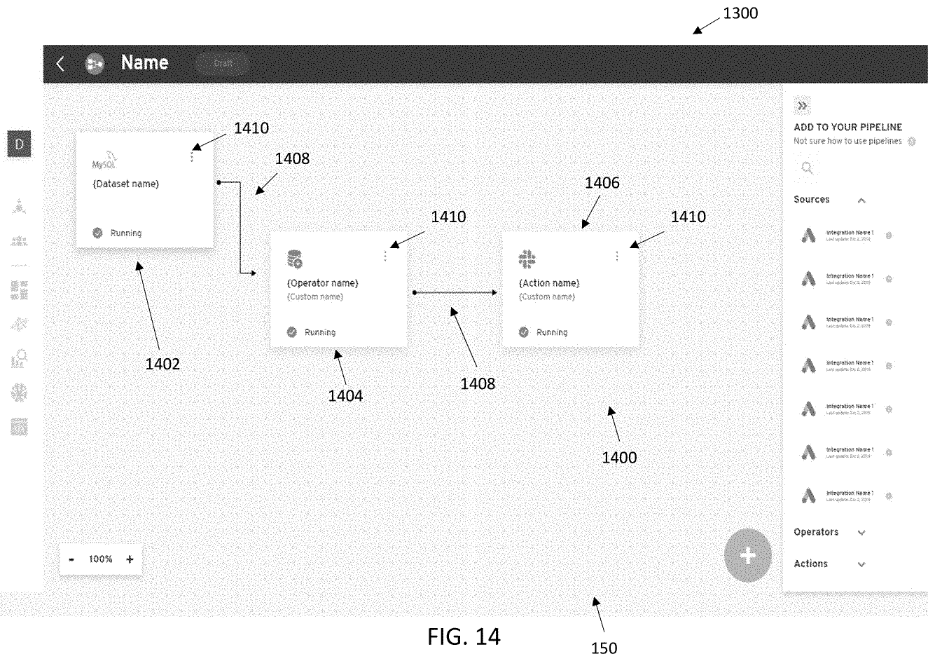

FIG. 14 depicts the exemplary graphical user interface (GUI) 1300 with an exemplary pipeline 1400. The pipeline 1400 can include an graphical block or nodes 1402 representing executable code for integrating an integrated data source 120 into the pipeline 1400, a graphical block 1404 representing executable code for an operator 170 into the pipeline 1400, and a graphical block 1406 representing executable code for an action 180 into the pipeline 1400. Lines or edges 1408 can connect the graphical blocks 1402, 1404, and 1406 to define an order of execution of the executable code for the graphical blocks 1402, 1404, and 1406 for the pipeline 1400. The graphical blocks 1402, 1404, and 1406 can include a selectable menu option 1410 that allows the user to configure parameters of the executable code represented by the graphical blocks 1402, 1404, and 1406.

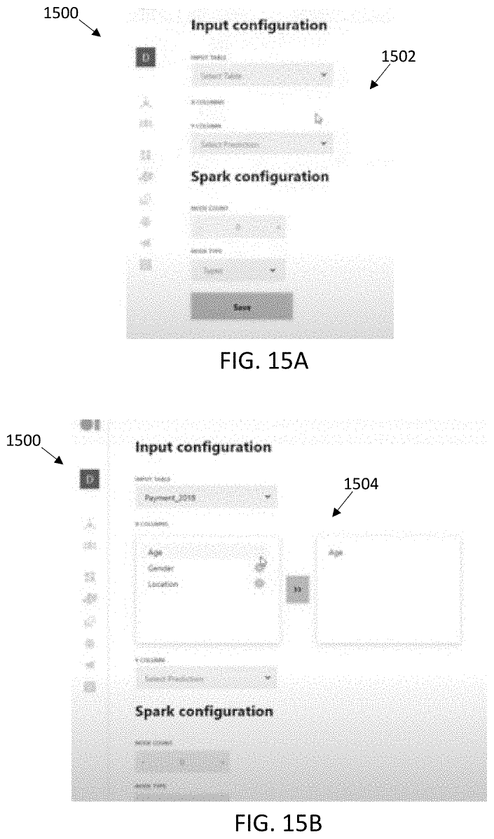

FIG. 15A-B depicts an exemplary graphical user interface (GUI) 1500 of an embodiment of the system 100 that can be rendered by the system 100. As a non-limiting example, the GUI 1500 can be rendered by the system 100 in response to a selection of a menu option on a graphical block corresponding to an operator 170 for a linear regression algorithm. The GUI 1500 can allow the user to configure parameters for the linear regression algorithm. For example, as shown in FIGS. 15A-B, the GUI 1500 can include data entry areas 1502 for receiving values for an input table, an x-column, a y-column, a mode count, and a mode type. As shown in FIG. 15B, the user selected the table “Payment_2018” and selected “age” for the x-column 1504.

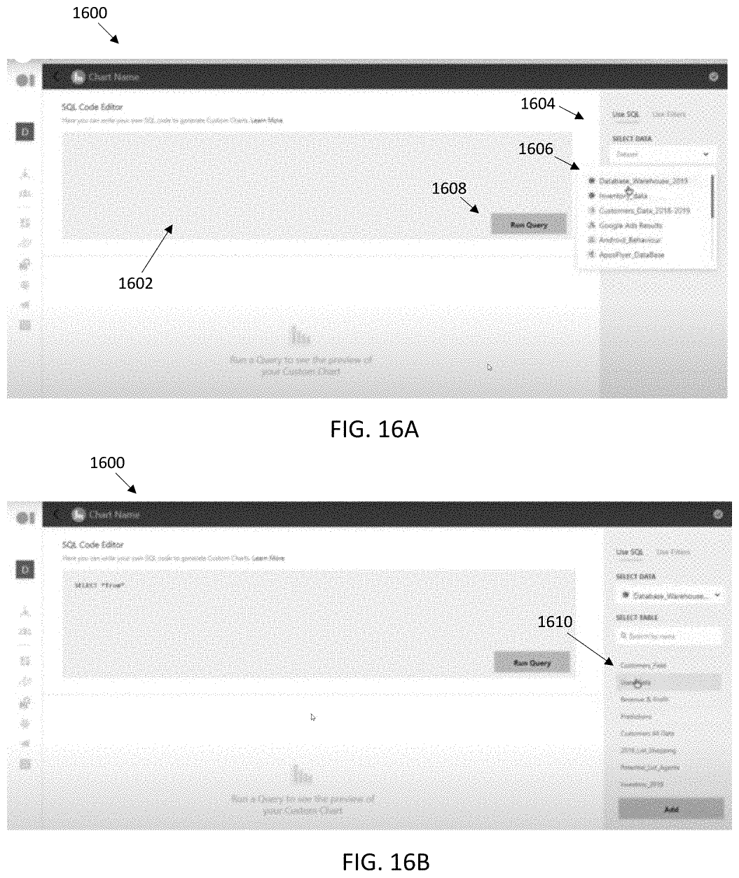

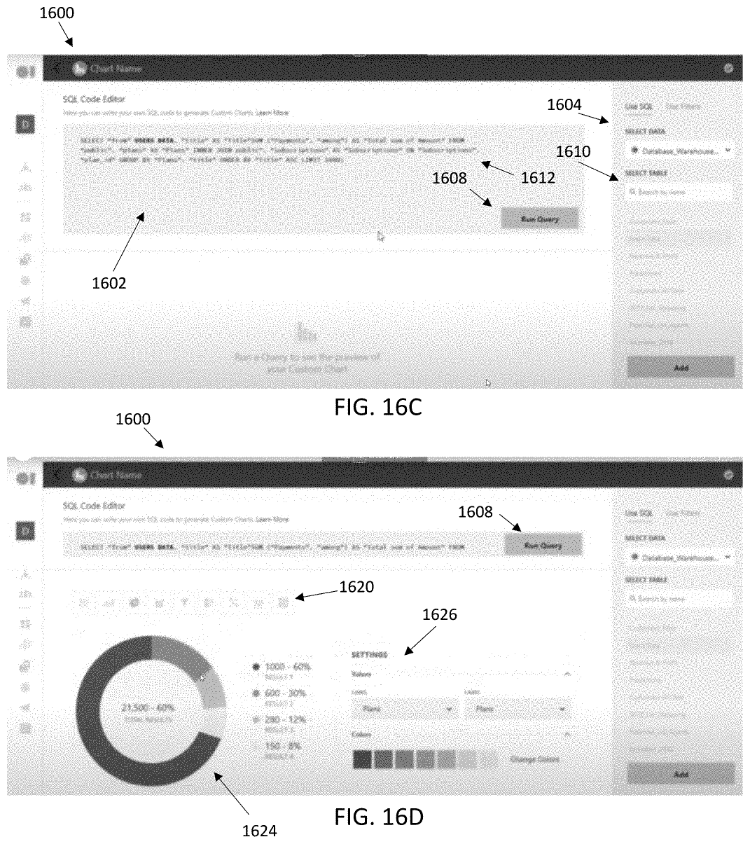

FIG. 16A-16D depicts an exemplary graphical user interface (GUI) 1600 of an embodiment of the system 100 to facilitate query generation. The GUI 1600 allows users to interface with an embodiment of the query generator 175. The GUI 1600 can include a data entry field 1602 where the database query can be generated. The data entry field 1602 can be automatically populated by the system in response to receipt of selections made by the user in the GUI 1600, and/or can allow the user to manually generate and/or modify a database query, which can be executed in response to selection of the “Run Query” option 1608. As an example, the user can select a data source 1604 from one of the integrated data sources 120 using a drop down menu 1606 (FIG. 16A). After the system receives a selection of one of the integrated data sources 120, the GUI allows the user to select a data table 1610 for the query and can provide the user with a list of possible data tables 1612 in the integrated data source (FIG. 16B). After the system 100, receives a selection of the integrated data source and one or more tables, the query generator 175 can generate query code 1612 (e.g., in SQL) and can populate the data entry field 1602 with the query code 1612 (FIG. 16C). In response to selecting the Run Query option 1608, the system 100 can return a data set and can present the data set to the user in one or more forms. As an example, as shown in FIG. 16D, the system 100 can include options 1620 to allow the user to specify how the data returned from the integrated data source is presented. For example, the data can be displayed in a table and/or can displayed in one or more graphical charts. In the example shown in FIG. 16D, the user has selected to have the system present the data as a chart 1624. The settings 1626 of the chart 1624 can be configurable by the user to customize the presentation of the data. For example, a title, labels, and/or a color scheme can be specified for the chart 1624. The user can save one or more of the tables or charts generated using the GUI 1600 and query generator 175 to the project dashboard (e.g., in one of the boards on the dashboard) and/or can choose to add the query code to a pipeline as an operator 170 or an action 180. If the user chooses to add the query code to a pipeline, a graphical block representing the query code can be added to the pipeline, and the query code can be executed each time the pipeline is executed.

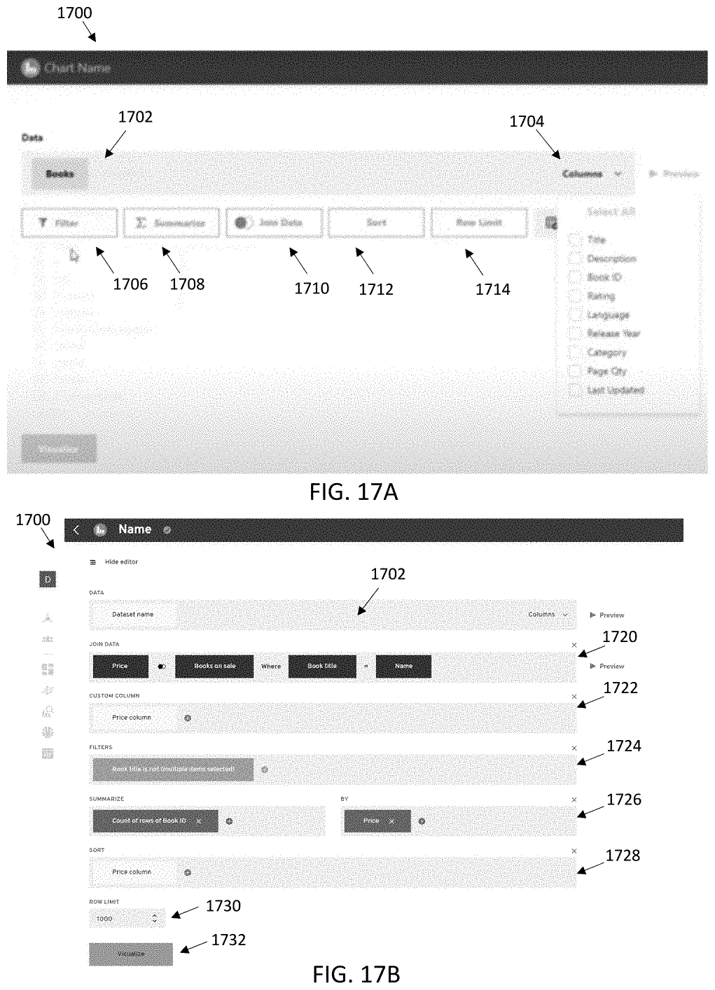

FIG. 17A-B depicts an exemplary graphical user interface (GUI) 1700 of an embodiment of the system 100 that can be rendered by the system 100. The GUI 1700 allows users to interface with an embodiment of the query generator 175 that returns data from one or more selected integrated data sources using one or more filters or operations. The GUI 1600 can include a data entry field 1602 where the database query can be generated. As shown in FIG. 17A, the user can select data to be returned from an integrated data sources in a data entry field 1702 and can specify columns of the data using a drop down menu 1704. Once the data and column(s) of the integrated data source have been specified, the user can select one or more operations to be performed on the data in the specified columns. As an example, the user can select a filter option 1706 to have the system 100 apply a data filter to the data columns, a summarize option 1708 to have the system perform a summation of data in the specified columns, a join data option to have the system 100 join data from one or more columns and/or integrated data sources, a sort option 1712 to have the system sort the data according to data in one or more of the specified columns, and/or a row limit option 1714 to have the system 100 limit the number of rows of data that are returned for the specified columns.

As shown in FIG. 17B, in one embodiment, the GUI 1700 can include data entry fields 1720, 1722, 1724, 1726, 1728, and/or 1730 for specifying operations to be performed on data in one or more of the integrated data sources 120. As an example, the data entry field 1720 can allow the user to specify parameters for a join operation without having to write any code, data entry field 1722 can allow the user to specify a custom column, data entry field 1724 can allow the user to specify filters for the data, data entry fields 1726 can allow the user to specify parameters for a summarization operation to be performed on the data, data entry field 1728 can allow the user to specify columns by which the data is to be sorted, and data entry field 1732 allows the user to specify a value for a row limit to limit the number of rows of data that are returned. After the user has specified one or more parameters, the user can select the “Visualize” option 1732 to retrieve the data from the selected one or more integrated data sources 120 and to present the data to the user in a manner similar to that as shown in and described in relation to FIG. 16D.

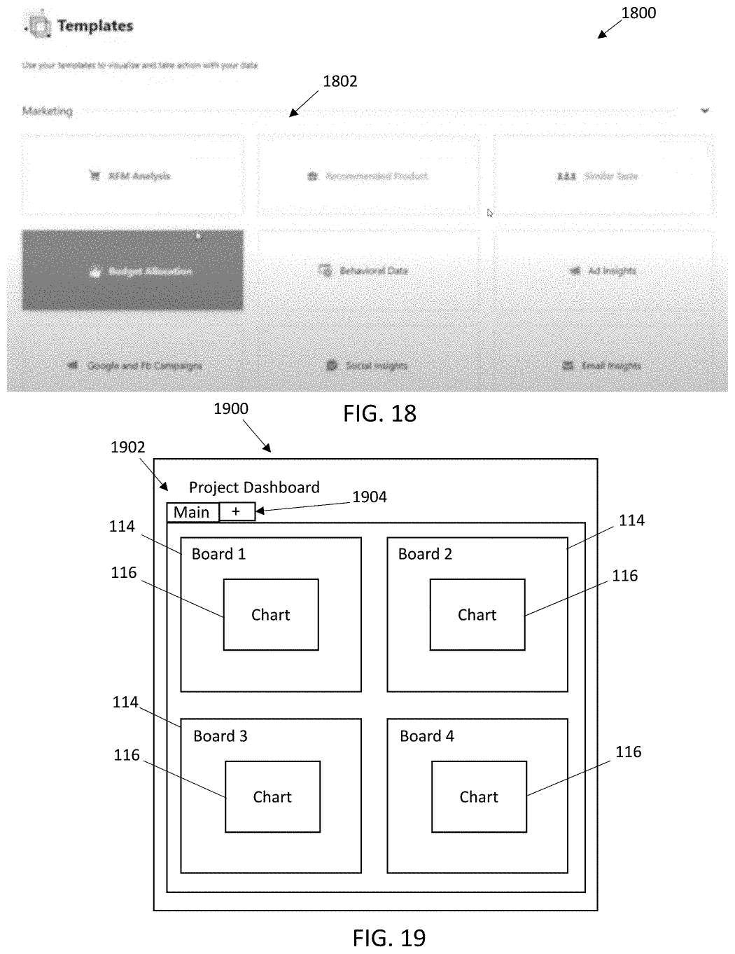

FIG. 18 depicts an exemplary graphical user interface (GUI) 1800 of an embodiment of the system 100 that can be rendered by the system 100. The GUI 1800 can provide the user with icons 1802 corresponding to pipeline templates that the user can add to a project. The templates can be prefabricated pipelines including executable code for providing specific outputs based on data in one or more of the integrated data sources 120. In one example, one or more of the templates can correspond to pipelines for digital marketing including RFM analysis, Recommended Products, Similar Taste, Budget allocation for advertising/marketing, behavioral data (to build a Custom Funnel), advertising insights, advertising campaigns for web and/or social media content, analysis of social media advertising (Social Insights), and analysis of e-mail advertising (Email insights). In response to selection of one of the icons 1802, the system 100 can provide the user with a menu through which the user can specify data to be processed by the template and to specify one or more parameters for the operations to be performed by the template. Once the user has specified and/or configured the template for their data, the system 100 can add the template to a project, can add one or more charts 116 corresponding to the outputs of the templates to the boards 114, and/or can send the output of the template to an application embedded in or external to the system 100.

FIG. 19 depicts an exemplary graphical user interface (GUI) 1900 of an embodiment of the system 100 that can be rendered by the system 100. The GUI 1900 illustrates an exemplary dashboard for a project. The dashboard can include one or more pages and can allow users to add pages. As a non-limiting example, the GUI 1900 can include a “Main” page 1902, and can include an option 1904 to add another page to the dashboard. The dash board can include one or more boards 114 and/or charts 116. The boards 114 can be rearranged on the dashboard to allow the user to customize the presentation of data and analysis for the project.

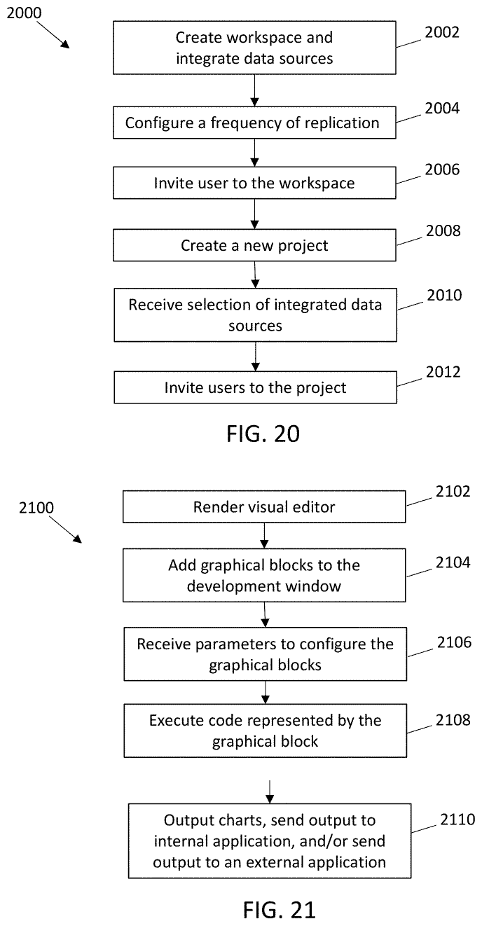

FIG. 20 is a flowchart of an exemplary process 2000 for generating a project in a workspace of an embodiment of the system. At operation 2002, the system 100 can create a workspace and integrate data sources in response to selections of data sources from a user. At operation 2004, configure a frequency for data replication for the selected data sources. Data from the data sources can be saved and updated in the system 100 at the specified frequency, e.g., hourly, daily, weekly, monthly, quarterly, etc. At operation 2006, invite users to the workspace. At operation 2008, create and name a new project. At operation 2010, receive a selection of the integrated data sources to build a pipeline in the new project. At operation 2012, invite people to the new project. After a new project is created, a dashboard for the project is created and one or more charts and/or pipelines can be created using the visual editor 150 and/or query editor 175. The charts, actions, and templates can be added as boards in the dashboard. As an example, the user can select a pipelines option view pipelines for the project and/or to create new pipelines. A user can select one of the existing pipelines to open the existing pipeline in the visual editor and/or can select a create new pipeline option to open the visual editor. Once the visual editor is open, the user can graphically add graphical blocks to create or modify a pipeline.

FIG. 21 is a flowchart illustrating an exemplary process 2100 for generating a pipeline in an embodiment of the system 100. At operation 2102, a visual editor can be rendered on user display. At operation 2104, the system 100 can receive selections of one or more graphical blocks corresponding executable code for one or more integrated data sources 120, operations 180, and/or actions 190, and add the graphical blocks to the development window of the visual editor. As the graphical blocks are added to the visual editor 150, the system can connect the graphical blocks with lines representing an order of execution for the executable code in each of the graphical blocks. At operation 2106, the system 2106 can receive parameters to configure the executable code represented by the graphical blocks. At operation 2108, the user can run or execute the pipeline created using the graphical blocks to execute the executable code and generate one or more outputs from the pipeline. At operation 2110, the outputs from the pipeline can be one or more charts, can be sent to an application internal to the system 100, and/or can be sent to an application external to the system 100 without requiring the user to build a API to provide an interface between the system 100 and the external application. As a non-limiting example, the actions 190 included in the pipeline can be used to create or update users in a Customer Relationship Management (CRM) system based on predictions output by one or more of the machine learning algorithms or other outputs from other operators in the pipeline, send messages via communications platforms like Slack, generate one or more charts, provide data for SMS messages directed to specific customers based on predictions output by one or more of the machine learning algorithms or other operators in the pipeline, generate an audience for advertising campaign for the web or social media, and/or generate a spreadsheet.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes a plurality of system elements, device components or method steps, those elements, components or steps may be replaced with a single element, component or step. Likewise, a single element, component or step may be replaced with a plurality of elements, components or steps that serve the same purpose. Moreover, while example embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Example flowcharts are provided herein for illustrative purposes and are non-limiting examples of methods. One of ordinary skill in the art will recognize that example methods may include more or fewer steps than those illustrated in the example flowcharts, and that the steps in the example flowcharts may be performed in a different order than the order shown in the illustrative flowcharts.

1. A method for generating an end-to-end data pipeline, the method comprising:
rendering one or more graphical user interfaces for establishing a workspace and a project in the workspace;
integrating data sources into the workspace from one or more data sources in response to input from a user in the one or more graphical user interfaces;
rendering a visual editor in the one or more graphical user interfaces;
populating a development window of the visual editor with graphical blocks representing executable code and lines connecting the graphical blocks to define a sequence of code and an order of execution of the executable code represented by the graphical blocks without requiring the user to write code;
executing the sequence of code in the order defined by the graphical blocks; and
in response to execution of the executable code corresponding to at least one of the graphical blocks, sending an output from the execution of the sequence of code to an application for consumption without requiring the user to generate an application program interface.

2. The method of claim 1, wherein integrating the data sources includes at least one of integrating data from one or more data repositories, third party applications or integrating data from a pixel embedded in web content or social media content.

3. The method of claim 1, further comprising:
generating one or more charts based on the output or in response to query code or a data filter.

4. The method of claim 3, wherein the query code is generated automatically in response to a selection of one of the data sources that have been integrated and a data table in the data source that is selected.

5. The method of claim 1, further comprising:
defining a dashboard for the project, the dash being configurable to render one or more visualizations for the data of the data sources or the output of the execution of the sequence of code.

6. The method of claim 1, further comprising:
configuring parameters of the executable code represented by the graphical blocks in response to input from a user.

7. The method of claim 1, further comprising:
managing at least one of processor or memory resources including automatically scaling processor or memory resources during execution of the sequence of code and scheduling of Machine Learning pipeline jobs.

8. The method of claim 1, wherein an operator included in the graphical blocks corresponds to executable code for a machine learning algorithm and the method further comprises:
training the machine learning algorithm based on at least one of input test data selected by the user or input test data automatically identified and selected by the processor; and
subsequent to training the machine learning algorithm, executing the machine learning algorithm to output one or more predictions or classifications.

9. A system an end-to-end data pipeline, the system comprising:
a non-transitory computer-readable medium storing instructions; and
a processor programmed to execute the instructions to:
render one or more graphical user interfaces for establishing a workspace and a project in the workspace;
integrate data sources into the workspace from one or more data sources in response to input from a user in the one or more graphical user interfaces;
render a visual editor in the one or more graphical user interfaces;
populate a development window of the visual editor with graphical blocks representing executable code and lines connecting the one or more graphical blocks to define a sequence of code and an order of execution of the executable code represented by the graphical blocks without requiring the user to write code;
execute the sequence of code in the order defined by the graphical blocks; and
in response to execution of the executable code corresponding to at least one of the graphical blocks, send an output from the execution of the sequence of code to an application for consumption without requiring the user to generate an application program interface.

10. The system of claim 9, wherein the data sources that have been integrated include at least one of integrating data from one or more data repositories or integrating data from a pixel embedded in web content or social media content.

11. The system of claim 9, wherein the processor is programmed to generate one or more charts based on the output or in response to query code or a data filter.

12. The system of claim 11, wherein the processor generates the query code automatically in response to a selection of one of the data sources that have been integrated and a data table in the data source that is selected.

13. The system of claim 9, wherein the processor is programmed to define a dashboard for the project, the dash being configurable to render one or more visualizations for the data of the data sources or the output of the execution of the sequence of code.

14. The system of claim 9, wherein the processor is programmed to configure parameters of the executable code represented by the graphical blocks in response to input from a user.

15. The system of claim 9, wherein the processor is programmed to manage at least one of processor or memory resources including automatically scaling processor or memory resources during execution of the sequence of code and scheduling of Machine Learning pipeline jobs.

16. The system of claim 9, wherein an operator included in the graphical blocks corresponds to executable code for a machine learning algorithm and the processor is programmed to:
train the machine learning algorithm based on at least one of input test data selected by the user or input test data automatically identified and selected by the processor; and
subsequent to training the machine learning algorithm, execute the machine learning algorithm to output one or more predictions or classifications.

17. A non-transitory computer-readable medium comprising instructions, wherein execution of the instruction by a processor causes the processor to:
render one or more graphical user interfaces for establishing a workspace and a project in the workspace;
integrate data sources into the workspace from one or more data sources in response to input from a user in the one or more graphical user interfaces;
render a visual editor in the one or more graphical user interfaces;
populate a development window of the visual editor with graphical blocks representing executable code and lines connecting the one or more graphical blocks to define a sequence of code and an order of execution of the executable code represented by the graphical blocks without requiring the user to write code;
execute the sequence of code in the order defined by the graphical blocks; and
in response to execution of the executable code corresponding to at least one of the graphical blocks, send an output from the execution of the sequence of code to an application for consumption without requiring the user to generate an application program interface.

18. The medium of claim 17, wherein execute of the instructions by the processor causes the processor to generate one or more charts based on an output or in response to query code or a data filter, the query code being automatically generated by the processor in response to a selection of one of the data sources that have been integrated and a data table in the data source that is selected.

19. The medium of claim 17, wherein execution of the instructions by the processor causes the processor to generate executable code for a pixel to track user behavior in a web content or social media content, the pixel configured to be copied and embedded in the web content or social media content.

20. The medium of claim 17, wherein an operator included in the graphical blocks f corresponds to executable code for a machine learning algorithm and execution of the instructions by the processor causes the processor to:
train the machine learning algorithm based on at least one of input test data selected by the user or input test data automatically identified and selected by the processor; and
subsequent to training the machine learning algorithm, execute the machine learning algorithm to output one or more predictions or classifications.
